(19) United States
(12) Patent Application Publication
(10) Pub. No.: US 2024/0010066 A1
(43) Pub. Date: Jan. 11, 2024

(54) VEHICLE, HYDRAULIC SYSTEM FOR POWERTRAIN OF VEHICLE, AND CONTROL METHOD THEREOF

(71) Applicant: BYD COMPANY LIMITED, Shenzhen (CN)

(72) Inventors: Futang ZHU, Shenzhen (CN); Hui ZHANG, Shenzhen (CN); Chunsheng WANG, Shenzhen (CN)

(21) Appl. No.: 18/372,249

(22) Filed: Sep. 25, 2023

Related U.S. Application Data
(63) Continuation of application No. PCT/CN2022/085872, filed on Apr. 8, 2022.

(30) Foreign Application Priority Data
Apr. 15, 2021 (CN) 202110406463.8

(51) Int. Cl. B60K 11/02; F01M 5/00

(52) U.S. Cl. CPC B60K 11/02; F01M 5/002

(57) ABSTRACT

A hydraulic system for a powertrain of a vehicle, the powertrain includes a drive motor, a generator, a clutch, or a transmission system. The hydraulic system includes: an oil tank; a main cooling oil path, a first end of the main cooling oil path being communicated with the oil tank, where a first oil pump and a cooler are disposed on the main cooling oil path; and multiple cooling branches, the cooling branches connected to a second end of the main cooling oil path, the first oil pump configured to pump an oil in the oil tank to the cooling branches, a control element disposed on each of the cooling branches, the control element configured to control opening and closing of a corresponding cooling branch, and the cooling branches configured to cool one or more of the drive motor, the generator, the clutch, and the transmission system.

### CROSS-REFERENCE TO RELATED APPLICATION

This application is a Continuation application of International Patent Application No. PCT/CN2022/085872, filed on Apr. 8, 2022, which is based on and claims priority to and benefits of Chinese Patent Application No. 202110406463.8, filed on Apr. 15, 2021. The entire content of all of the above-referenced applications is incorporated herein by reference.

### FIELD

The present disclosure relates to the field of vehicles, and particularly to a vehicle, a hydraulic system for a powertrain of a vehicle, and a control method thereof.

### BACKGROUND

With the diversification of energy sources for vehicles, the powertrain of a hybrid vehicle integrates components in many fields, including gears, clutches, drive motors, generators, controllers, etc. These parts need to be cooled to operate at appropriate temperatures. In the related art, cooling oil paths of a plurality of parts are controlled by a pump, and the cooling oil paths of the parts are respectively connected to the pump through throttle valves. Particularly, the cooling and lubrication of the parts are distributed according to the ratio of the sizes of the throttle valves. Therefore, in the related art, to satisfy the flow rate required by a part having the highest cooling demand, the supply of cooling for other parts is likely to exceed corresponding demands, and some parts cannot operate in an efficient temperature range, resulting in low efficiency of the powertrain.

### SUMMARY

The present disclosure solves, at least to some extent, one of the technical problems in the related art.

The present disclosure provides a vehicle, a hydraulic system for a powertrain of a vehicle, and a method for controlling the hydraulic system, so that the flow for each power terminal can be adjusted as required.

An embodiment of a first aspect of the present disclosure provides a hydraulic system for a powertrain of a vehicle. The powertrain includes one or more of a drive motor, a generator, a clutch, and a transmission system. The hydraulic system includes an oil tank, a main cooling oil path, and a plurality of cooling branches. A first end of the main cooling oil path is communicated with the oil tank. A first oil pump and a cooler are disposed on the main cooling oil path. The plurality of cooling branches are connected to a second end of the main cooling oil path. The first oil pump is configured to pump an oil in the oil tank to the cooling branches. A control element is disposed on each of the cooling branches. The control element is configured to control opening and closing of the corresponding cooling branch. The plurality of cooling branches is configured to cool one or more of the drive motor, the generator, the clutch, and the transmission system.

The cooling branches and the control elements form an integrated cooling valve group structure, and each solenoid valve can independently open or close and adjust the cooling branch, to realize independent flow control, thereby independently adjusting and controlling the cooling flow for each power terminal.

An embodiment of a second aspect of the present disclosure provides a vehicle, including the hydraulic system, a controller, a power distribution module, a pressure calculation module, a terminal flow calculation module, and a hydraulic coordination module. The controller is configured to receive traveling demand information and road condition information. The power distribution module is configured to calculate rotation speed information and torque information corresponding to each power terminal of the powertrain according to the traveling demand information and the road condition information. Each power terminal includes one or more of a drive motor, a generator, a clutch, and a transmission system. The pressure calculation module is configured to calculate a driving pressure requirement according to the rotation speed information and the torque information from the power distribution module. The terminal flow calculation module is configured to calculate a cooling flow requirement of each power terminal according to the rotation speed information and the torque information from the power distribution module and an oil temperature of the main cooling oil path. The hydraulic coordination module is configured to calculate a rotation speed of the first oil pump, a rotation speed of the second oil pump, the opening degree of the control element, and an opening degree of the pressure control solenoid valve according to the driving pressure requirement and the cooling flow requirement of each power terminal.

An embodiment of a third aspect of the present disclosure provides a method for controlling a hydraulic system for a powertrain of a vehicle, including:

calculating rotation speed information and torque information corresponding to each power terminal of the powertrain according to the traveling demand information and the road condition information, each power terminal including one or more of a drive motor, a generator, a clutch, and a transmission system; calculating a driving pressure requirement and a cooling flow requirement of each power terminal according to the rotation speed information and the torque information corresponding to each power terminal; and calculating a rotation speed of the first oil pump, a rotation speed of the second oil pump, flow rates in the cooling branches, and an opening degree of the pressure control solenoid valve according to the driving pressure requirement and the cooling flow requirement of each power terminal.

Additional aspects and advantages of the present disclosure will be partly given in and partly apparent from the description below, or understood through practice of the present disclosure.

### BRIEF DESCRIPTION OF THE DRAWINGS

FIG. 1 is a schematic diagram of a hydraulic system according to an embodiment of the present disclosure;

FIG. 2 is a schematic diagram of a hydraulic system according to an embodiment of the present disclosure (where a hybrid vehicle operates in an electric vehicle mode);

FIG. 3 is a schematic diagram of a hydraulic system according to an embodiment of the present disclosure (where a hybrid vehicle operates in a parallel mode);

FIG. 4 is a schematic diagram of a hydraulic system according to an embodiment of the present disclosure (where a hybrid vehicle operates in a serial mode);

FIG. 5 and FIG. 6 are each a schematic diagram of an oil pump of a hydraulic system according to another embodiment of the present disclosure;

FIG. 7 is a schematic diagram of a cooling branch of a hydraulic system according to still another embodiment of the present disclosure;

FIG. 8 is a schematic diagram of constituent modules of a vehicle according to an embodiment of the present disclosure;

FIG. 9 is a schematic diagram of a method for controlling a hydraulic system according to an embodiment of the present disclosure; and

FIG. 10 is a schematic diagram of a vehicle according to an embodiment of the present disclosure.

### DETAILED DESCRIPTION

Embodiments of the present disclosure will be described in detail below with reference to the accompanying drawings in which the same or like reference characters refer to the same or like elements or elements having the same or like functions throughout. The embodiments described below with reference to the accompanying drawings are exemplary, and are intended to explain the present disclosure, rather than limiting the present disclosure.

A vehicle 1000, a hydraulic system for a powertrain of a vehicle 1000, and a method for controlling same according to the embodiments of the present disclosure will be described in detail below with reference to the accompanying drawings.

An embodiment of a first aspect of the present disclosure provides a hydraulic system 100 for a powertrain of a vehicle 1000. The vehicle 1000 includes one or more of a drive motor, a generator, a clutch, and a transmission system. The hydraulic system includes an oil tank 10, a main cooling oil path m, and a plurality of cooling branches.

As shown in FIG. 1, one end (e.g., a first end) of the main cooling oil path m is communicated with the oil tank 10, and a first oil pump 20 is arranged/disposed on the main cooling oil path m. The first oil pump 20 is configured to pump an oil in the oil tank 10 to the cooling branches. The plurality of cooling branches are connected to another end (e.g., a second end) of the main cooling oil path m. An independently controlled control element is arranged/disposed on each of the plurality of cooling branches. The control element is configured to control opening and closing of the corresponding cooling branch. The plurality of cooling branches are configured to cool one or more of a drive motor 50a, a clutch 50b, a transmission system 50c, and a generator 50d.

Each of the cooling branches n corresponds to cooling of one power terminal. The power terminal includes but is not limited to the drive motor 50a, the clutch 50b, the transmission system 50c, and the generator 50d.

Therefore, the cooling branches and the control elements form an integrated cooling valve group structure, and each solenoid valve can independently open or close and adjust the cooling branch, to realize independent flow control, thereby independently adjusting and controlling the cooling flow for each power terminal.

In some embodiments, the cooling branches at least include a first cooling branch n1, a second cooling branch n2, a third cooling branch n3, and a fourth cooling branch n4. The first cooling branch n1 is configured to cool the drive motor 50a. The second cooling branch n2 is configured to cool the generator 50d. The third cooling branch n3 is configured to cool the clutch 50b. The fourth cooling branch n4 is configured to cool the transmission system 50c. Accordingly, the control elements on the cooling branches are respectively a first control element a second control element 40b, a third control element 40c, and a fourth control element 40d.

Therefore, there is a form of energy consumption or multiple energy sources participating in driving at the same time in the operation of a hybrid vehicle. For example, the hybrid vehicle is in an electric vehicle mode (where the drive motor 50a participates in driving, but an engine and the generator 50d do not operate) or a parallel mode (where the engine and the drive motor 50a participate in driving at the same time). The drive motor 50a, the generator 50d, the clutch 50b, and the transmission system 50c are respectively cooled by the first cooling branch n1, the second cooling branch n2, the third cooling branch n3, and the fourth cooling branch n4. A cooler 30 is arranged/disposed on the main cooling oil path m to cool the oil in the main cooling oil path m and the cooling branches. This not only can realize the cooling of each power terminal, but also provides a cooling effect.

The control elements are proportional adjustment solenoid valves, and each of the proportional adjustment solenoid valves is configured to receive a signal sent by a vehicle controller and to adjust an opening degree of each of the proportional adjustment solenoid valves according to the signal. Therefore, the proportional adjusting solenoid valves not only can control the opening and closing of the corresponding cooling branches, but also can adjust the flow rate in each cooling branch as required.

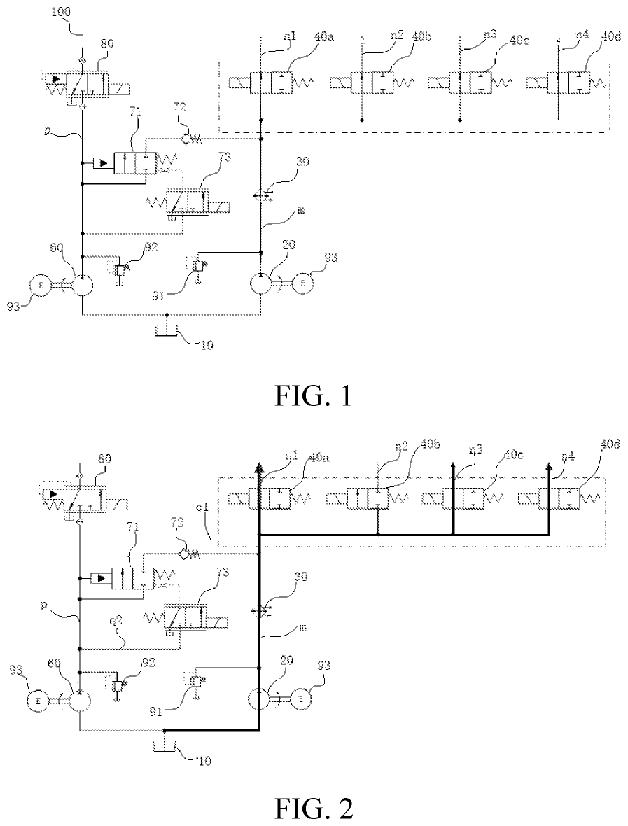

In the embodiment shown in FIG. 1 and FIG. 2, the hydraulic system 100 further includes a driving oil path p. The driving oil path p is connected between the oil tank 10 and the clutch 50b. A second oil pump 60 and a pressure control solenoid valve 80 are arranged/disposed on the driving oil path p. The second oil pump 60 is configured to pump the oil to the driving oil path p. The driving oil path p is configured to supply the oil to the clutch.

In this way, the driving oil path p is connected between the clutch and the oil tank 10 and outputs pressure to control the closing and opening of the clutch. When pressure of the clutch needs to be increased according to a driving pressure requirement and current pressure of the clutch, the pressure control solenoid valve 80 is communicated with the driving oil path p and the clutch and controls the second oil pump 60 to operate. When pressure of the clutch needs to be relieved, the pressure control solenoid valve 80 blocks the communication between the driving oil path p and the clutch, and communicates the oil tank 10 and the clutch.

In addition, the main cooling oil path m may further be connected to a first safety branch. The first safety branch is located between the cooler 30 and the first oil pump 20. A first safety valve 91 is arranged/disposed on the cooling branches. The first safety valve 91 is connected to the oil tank 10 to relieve pressure when oil pressures in the main cooling oil path m and the cooling branches exceed a preset pressure.

Similarly, the driving oil path p may further be connected to a second safety branch. The second safety branch is arranged/disposed close to the second oil pump 60. The second safety valve 92 is connected to the oil tank 10 to relieve pressure when an oil pressure in the driving oil path p exceeds a preset pressure.

In some embodiments, as shown in FIG. 1 to FIG. 4, the hydraulic system further includes two pump motors 93 (e.g., a first pump motor and a second pump motor), one of the pump motors 93 (e.g., the first pump motor) is in transmission connection with the first oil pump 20 and the other pump motor 93 (e.g., the second pump motor) is in transmission connection with the second oil pump 60. The first oil pump 20 and the second oil pump 60 are respectively controlled by the two pump motors 93, so that the oil pressures in the driving oil path p and the main cooling oil path m can be precisely controlled.

In some other embodiments, as shown in FIG. 6, the hydraulic system further includes one pump motor 93, one end of the pump motor 93 is connected to the first oil pump 20, and another end of the pump motor 93 is connected to the second oil pump 60;

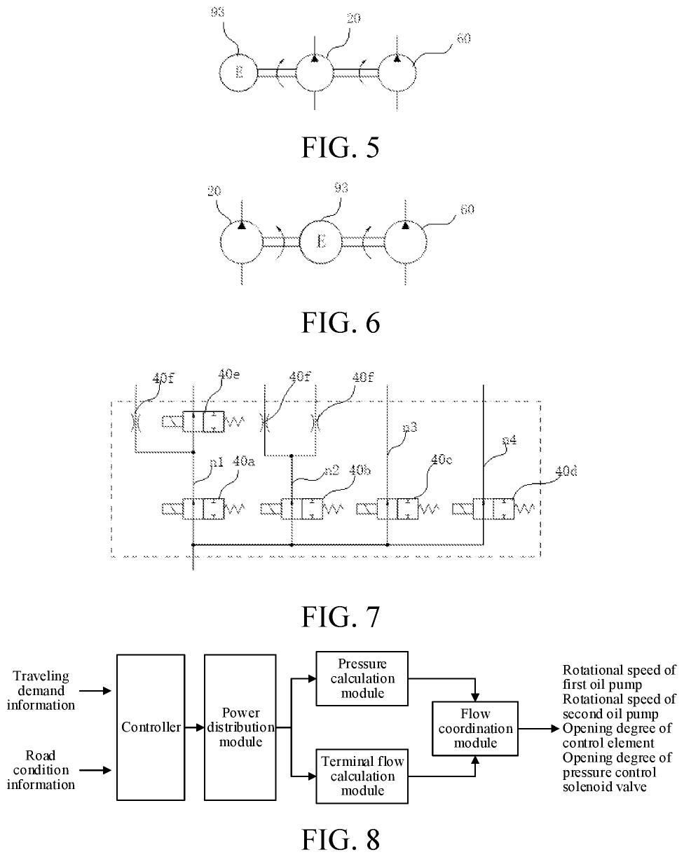

In an embodiment, as shown in FIG. 5. the hydraulic system further includes one pump motor 93, one end of the pump motor 93 is sequentially in serial transmission connection with the first oil pump 20 and the second oil pump 60. The first oil pump 20 and the second oil pump 60 are simultaneously controlled by the one pump motor 93, thereby simplifying the structure of the hydraulic system 100 and reducing the costs of the hydraulic system 100.

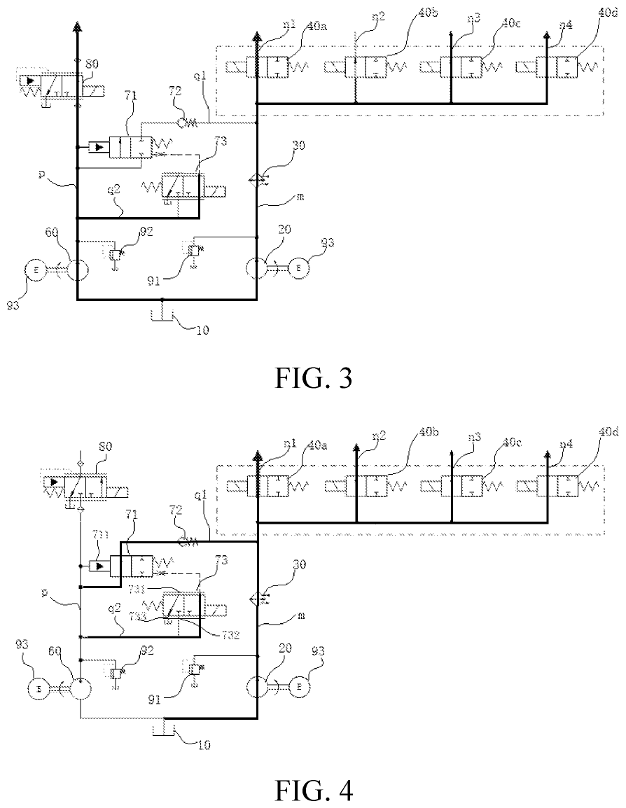

As shown in FIG. 3, the hydraulic system 100 further includes a replenishing oil path, the replenishing oil path is connected between the driving oil path p and the main cooling oil path m, and when the replenishing oil path is configured to communicate with the main cooling oil path, the oil in the driving oil path p flows unidirectionally to the main cooling oil path m.

Therefore, when the pressure control solenoid valve 80 is opened, the oil in the oil tank 10 may be pumped out by the second oil pump 60 through the driving oil path p and supplied to the clutch, the replenishing oil path is disconnected, and the driving oil path p and the second oil pump 60 are not used to replenish oil to the main cooling oil path m. When the flow in the cooling oil path is insufficient, the cooling oil path needs to be replenished with oil through the driving oil path, and the pressure control solenoid valve 80 is closed. In this case, the replenishing oil path is switched to communicate the driving oil path p with the main cooling oil path m under the action of pressure, and the oil in the oil tank 10 enters the replenishing oil path through the driving oil path p and the second oil pump 60, to provide an oil replenishing function for the cooling branches.

In the embodiment shown in FIG. 4, the replenishing oil path includes a main replenishing oil path q1 and a regulating oil path q2. A pressure slide valve 71 and a one-way valve 72 are arranged/disposed on the main replenishing oil path q1. An inlet of the pressure slide valve 71 is connected to the driving oil path p. An outlet of the pressure slide valve 71 is connected to the main cooling oil path m through the one-way valve 72. The pressure slide valve 71 is opened when a pressure in the driving oil path p is greater than an opening threshold of the pressure slide valve 71. One end of the regulating oil path q2 is connected to the pressure slide valve 71, another end of the regulating oil path q2 is connected to the driving oil path p. A pressure solenoid valve 73 is further arranged/disposed on the regulating oil path q2. The pressure solenoid valve 73 is configured to adjust the opening threshold of the pressure slide valve 71.

In this way, the connection to or disconnection from the replenishing oil path may be realized by controlling the pressure in the driving oil path p. When the pressure in the driving oil path p is within a threshold range, the pressure solenoid valve 73 is controlled to be opened, to switch the regulating oil path q2 to communicate with a throttle hole 731 of the pressure slide valve 71. The pressure solenoid valve 73 can control the flow rate and the pressure of the throttle hole 731, to control the pressure slide valve 71 to enter an open state or a closed state, thereby realizing connection and disconnection of the main replenishing oil path q1. Therefore, the use of the electrically controlled pressure solenoid valve 73, the second oil pump 60, and the pressure slide valve 71 can realize connection and disconnection of the replenishing oil path, and achieve sensitive response.

In the embodiment shown in FIG. 7, each of the cooling branches further includes a plurality of sub-branches, and a sub-branch solenoid valve 40e or a sub-branch throttle valve 40f is arranged/disposed on each of the sub-branches. Therefore, the plurality of sub-branches can also cool different power terminals.

As shown in FIG. 8 and FIG. 10, a vehicle 1000 according to an embodiment of a second aspect of the present disclosure includes the hydraulic system 100 of the above embodiments, a controller 200, a power distribution module 300, a pressure calculation module 400, a terminal flow calculation module 500, and a flow coordination module.

The controller 200 is configured to receive traveling demand information and road condition information. For example, in a conventional driving mode, accelerator pedal information and road slope information are obtained. In an assisted driving mode, driver demand information and road condition prediction information are obtained. In an autonomous driving mode, acceleration requirement information is obtained.

The power distribution module 300 is configured to calculate rotation speed information and torque information required by each power terminal of the powertrain according to the traveling demand information and the road condition information. The power terminal includes one or more of a drive motor, a generator, a clutch, and a transmission system.

The pressure calculation module 400 is configured to calculate a driving pressure requirement according to the rotation speed information and the torque information from the power distribution module 300. Based on power transmission paths of the power distribution module 300, the pressure calculation module 400 calculates pressure requirements for switching between different power transmission paths, for example, a clutch engagement pressure requirement for switching from an engine serial mode to an engine-driven vehicle mode.

The terminal flow calculation module 500 is configured to calculate a cooling flow requirement of each power terminal according to the rotation speed information and the torque information from the power distribution module 300 and oil temperature information of the main cooling oil path.

The hydraulic coordination module 600 is configured to calculate a rotation speed of the first oil pump, a rotation speed of the second oil pump, the opening degree of the control element, and an opening degree of the pressure control solenoid valve according to the driving pressure requirement and the cooling flow requirement of each power terminal. In other words, rotation speed information of the first oil pump and opening degree information of the pressure control solenoid valve and the control elements are calculated according to the pressure requirement from the pressure calculation module 400 and a summarized flow requirement from the terminal flow calculation module 500. Rotation speed information of the second oil pump is calculated according to the summarized flow requirement of the terminal flow calculation module 500. According to the cooling flow requirement of each power terminal, flow information of the corresponding control element (which may be a solenoid valve) is calculated. Therefore, the terminal flow calculation part calculates, according to performance of each component at different temperatures, a cooling flow requirement corresponding to optimal efficiency of the component.

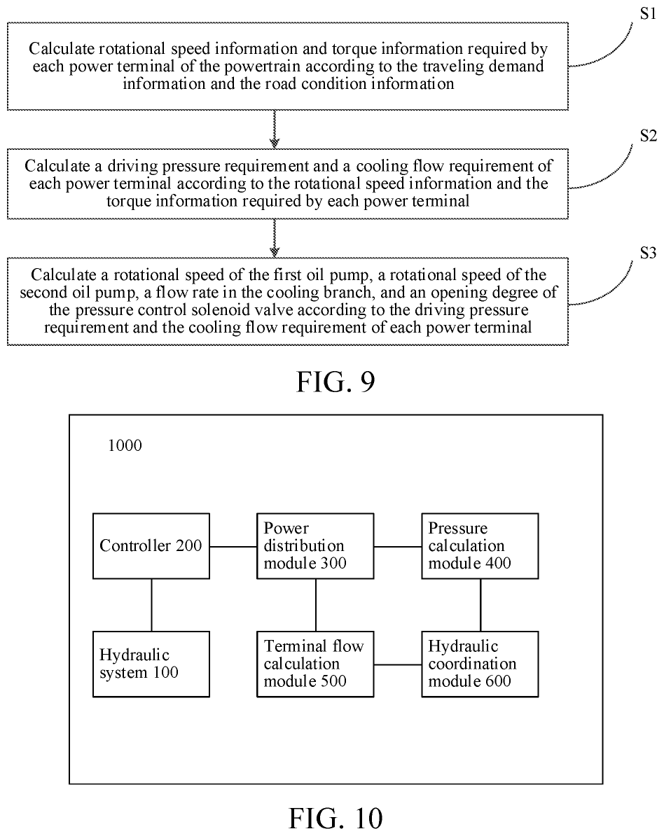

As shown in FIG. 9, an embodiment of a third aspect of the present disclosure provides a method for controlling a hydraulic system 100 for a powertrain of a vehicle, including the following steps.

S1: A power requirement of the powertrain is calculated according to driver demand information and predicted road condition information, and rotation speed information and torque information required by each power terminal of the powertrain are calculated.

S2: A flow requirement of each power terminal is calculated according to the rotation speed information and the torque information. A pressure requirement of the hydraulic system 100 is calculated according to a required pressure and the flow requirement of each power terminal.

S3: Rotation speeds of the oil pumps and a pressure and flow control signal required by each solenoid valve are calculated according to the pressure requirement and the flow requirement of each power terminal.

In this way, a cooling requirement of each component and a total cooling flow requirement are calculated according to a status of the vehicle, and oil pump signals are output, so that the system flow supply can be adjusted as required, thereby reducing the flow loss. By controlling the cooling flow to enable each power terminal to operate in an efficient temperature range, the cooling flow for each power terminal can be distributed as required, thereby improving the system efficiency.

Refer to Table 1 below for pressures of the hydraulic system 100 in different modes and the cooling flow for each power terminal.

TABLE 1

| | | Cooling flow | | | |
|---|---|---|---|---|---|
| | | Drive | | | Transmission |
| Vehicle mode | Pressure | motor | Generator | Clutch | system |
| EV | / | q₁ | / | q₂ | q₄ |
| Parallel connection | P1 | q₁′ | q₂′ | q₂′ | q₄′ |
| Serial connection | P2 | q₁″ | q₂″ | q₂″ | q₄″ |

Therefore, in the electric vehicle mode, there is no need to supply oil to the generator 50d; in the parallel mode, the second oil pump 60 supplies oil to the driving oil path p and the first oil pump 20 supplies coolant to the cooling branch; In the serial mode, the second oil pump 60 replenishes oil to the main cooling oil path m through the replenishing oil path.

Moreover, the terms “first” and “second” are used herein for purposes of description, and are not intended to indicate or imply relative importance or implicitly point out the number of the indicated technical feature. Therefore, the features defined by “first” and “second” may explicitly or implicitly include one or more features. In the description of the present disclosure, “multiple” and “a plurality of” mean two or more, unless otherwise particularly defined.

In the description of the specification, the description with reference to the terms “an embodiment”, “some embodiments”, “example”, “specific example”, or “some example” and so on means that features, structures, materials or characteristics described in connection with the embodiment or example are embraced in at least one embodiment or example of the present disclosure. In the specification, the illustrative expression of the above terms is not necessarily referring to the same embodiment or example. Moreover, the described features, structures, materials or characteristics may be combined in any suitable manners in one or more embodiments. In addition, where there are no contradictions, the various embodiments or examples described in this specification and features of various embodiments or examples can be combined by those skilled in the art.

Although the embodiments of the present disclosure have been illustrated and described above, it is to be understood that the above embodiments are exemplary and not to be construed as limiting the present disclosure, and that changes, modifications, substitutions and alterations can be made by those skilled in the art without departing from the scope of the present disclosure.

What is claimed is:

1. A hydraulic system for a powertrain of a vehicle, wherein the powertrain comprises one or more of a drive motor, a generator, a clutch, and a transmission system, and the hydraulic system comprises:
an oil tank;
a main cooling oil path, a first end of the main cooling oil path being communicated with the oil tank, wherein a first oil pump and a cooler are disposed on the main cooling oil path; and
a plurality of cooling branches, the cooling branches being connected to a second end of the main cooling oil path, the first oil pump being configured to pump an oil in the oil tank to the cooling branches, a control element being disposed on each of the cooling branches, the control element being configured to control opening and closing of a corresponding cooling branch, and the cooling branches being configured to cool one or more of the drive motor, the generator, the clutch, and the transmission system.

2. The hydraulic system according to claim 1, wherein the cooling branches comprise a first cooling branch, a second cooling branch, a third cooling branch, and a fourth cooling branch, the first cooling branch is configured to cool the drive motor, the second cooling branch is configured to cool the generator, the third cooling branch is configured to cool the clutch, and the fourth cooling branch is configured to cool the transmission system.

3. The hydraulic system according to claim 1, wherein the control element comprises proportional adjustment solenoid valves, and each of the proportional adjustment solenoid valves is configured to receive a signal sent by a vehicle controller and to adjust an opening degree of each of the proportional adjustment solenoid valves according to the signal.

4. The hydraulic system according to claim 1, further comprising a driving oil path, the driving oil path being connected between the oil tank and the clutch, a second oil pump and a pressure control solenoid valve being disposed on the driving oil path, the second oil pump being configured to pump the oil to the driving oil path, and the driving oil path being configured to control engagement and disengagement of the clutch.

5. The hydraulic system according to claim 4,
further comprising a first pump motor and a second pump motor, the first pump motor being in transmission connection with the first oil pump, and the second pump motor being in transmission connection with the second oil pump; or
further comprising one pump motor, one end of the pump motor being connected to the first oil pump, and the other end of the pump motor being connected to the second oil pump; or
further comprising one pump motor, one end of the pump motor being in serial transmission connection with the first oil pump and the second oil pump.

6. The hydraulic system according to claim 4, further comprising a replenishing oil path, the replenishing oil path being connected between the driving oil path and the main cooling oil path, wherein when the replenishing oil path is configured to communicate with the main cooling oil path, an oil in the driving oil path flows to the main cooling oil path.

7. The hydraulic system according to claim 6, wherein the replenishing oil path comprises:
a main replenishing oil path, wherein a pressure slide valve and a one-way valve are disposed on the main replenishing oil path, an inlet of the pressure slide valve is connected to the driving oil path, an outlet of the pressure slide valve is connected to the main cooling oil path through the one-way valve, and the pressure slide valve is opened when a pressure in the driving oil path is greater than an opening threshold of the pressure slide valve; and
a regulating oil path, wherein one end of the regulating oil path is connected to the pressure slide valve, another end of the regulating oil path is connected to the driving oil path, a pressure solenoid valve is disposed on the regulating oil path, the pressure solenoid valve is configured to adjust the opening threshold of the pressure slide valve.

8. The hydraulic system according to claim 1, wherein each of the cooling branches further comprises a plurality of sub-branches, and a sub-branch solenoid valve or a sub-branch throttle valve is disposed on each of the sub-branches.

9. A vehicle, comprising:
a powertrain comprising one or more of a drive motor, a generator, a clutch, and a transmission system;
a hydraulic system, comprising:
an oil tank;
a main cooling oil path, a first end of the main cooling oil path being communicated with the oil tank, wherein a first oil pump and a cooler are disposed on the main cooling oil path; and
a plurality of cooling branches, the cooling branches being connected to a second end of the main cooling oil path, the first oil pump being configured to pump an oil in the oil tank to the cooling branches, a control element being disposed on each of the cooling branches, the control element being configured to control opening and closing of a corresponding cooling branch, and the cooling branches being configured to cool one or more of the drive motor, the generator, the clutch, and the transmission system;
a controller, configured to receive traveling demand information and road condition information;
a power distribution module, configured to calculate rotation speed information and torque information corresponding to each power terminal of the powertrain according to the traveling demand information and the road condition information, wherein each power terminal comprises one or more of the drive motor, the generator, the clutch, and the transmission system;
a pressure calculation module, configured to calculate a driving pressure requirement according to the rotation speed information and the torque information from the power distribution module;
a terminal flow calculation module, configured to calculate a cooling flow requirement of each power terminal according to the rotation speed information and the torque information from the power distribution module and oil temperature information of the main cooling oil path; and
a hydraulic coordination module, configured to calculate a rotation speed of the first oil pump, a rotation speed of a second oil pump, an opening degree of the control element, and an opening degree of a pressure control solenoid valve according to the driving pressure requirement and the cooling flow requirement of each power terminal.

10. The vehicle according to claim 9, wherein the cooling branches comprise a first cooling branch, a second cooling branch, a third cooling branch, and a fourth cooling branch, the first cooling branch is configured to cool the drive motor, the second cooling branch is configured to cool the generator, the third cooling branch is configured to cool the clutch, and the fourth cooling branch is configured to cool the transmission system.

11. The vehicle according to claim 9, wherein the control element comprises proportional adjustment solenoid valves, and each of the proportional adjustment solenoid valves is configured to receive a signal sent by a vehicle controller and to adjust an opening degree of each of the proportional adjustment solenoid valves according to the signal.

12. The vehicle according to claim 9, wherein the hydraulic system further comprises a driving oil path, the driving oil path is connected between the oil tank and the clutch, the second oil pump and the pressure control solenoid valve are disposed on the driving oil path, the second oil pump is configured to pump the oil to the driving oil path, and the driving oil path is configured to control engagement and disengagement of the clutch.

13. The vehicle according to claim 12, wherein
the hydraulic system further comprises a first pump motor and a second pump motor, the first pump motor being in transmission connection with the first oil pump, and the second pump motor is in transmission connection with the second oil pump; or
the hydraulic system further comprises one pump motor, one end of the pump motor is connected to the first oil pump, and the other end of the pump motor is connected to the second oil pump; or
the hydraulic system further comprises one pump motor, one end of the pump motor is in serial transmission connection with the first oil pump and the second oil pump.

14. The vehicle according to claim 12, wherein the hydraulic system further comprises a replenishing oil path, the replenishing oil path is connected between the driving oil path and the main cooling oil path, wherein when the replenishing oil path is configured to communicate with the main cooling oil path, an oil in the driving oil path flows to the main cooling oil path.

15. The vehicle according to claim 14, wherein the replenishing oil path comprises:
a main replenishing oil path, wherein a pressure slide valve and a one-way valve are disposed on the main replenishing oil path, an inlet of the pressure slide valve is connected to the driving oil path, an outlet of the pressure slide valve is connected to the main cooling oil path through the one-way valve, and the pressure slide valve is opened when a pressure in the driving oil path is greater than an opening threshold of the pressure slide valve; and
a regulating oil path, wherein one end of the regulating oil path is connected to the pressure slide valve, another end of the regulating oil path is connected to the driving oil path, a pressure solenoid valve is disposed on the regulating oil path, the pressure solenoid valve is configured to adjust the opening threshold of the pressure slide valve.

16. The vehicle according to claim 9, wherein each of the cooling branches further comprises a plurality of sub-branches, and a sub-branch solenoid valve or a sub-branch throttle valve is disposed on each of the sub-branches.

17. A method for controlling a hydraulic system for a powertrain of a vehicle, wherein
the powertrain comprises one or more of a drive motor, a generator, a clutch, and a transmission system,
the hydraulic system comprises:
an oil tank;
a main cooling oil path, a first end of the main cooling oil path being communicated with the oil tank, wherein a first oil pump and a cooler are disposed on the main cooling oil path; and
a plurality of cooling branches, the cooling branches being connected to a second end of the main cooling oil path, the first oil pump being configured to pump an oil in the oil tank to the cooling branches, a control element being disposed on each of the cooling branches, the control element being configured to control opening and closing of a corresponding cooling branch, and the cooling branches being configured to cool one or more of the drive motor, the generator, the clutch, and the transmission system, and
the method comprises:
calculating rotation speed information and torque information corresponding to each power terminal of the powertrain according to traveling demand information and road condition information, wherein each power terminal comprises one or more of the drive motor, the generator, the clutch, and the transmission system;
calculating a driving pressure requirement and a cooling flow requirement of each power terminal according to the rotation speed information and the torque information corresponding to each power terminal; and
calculating a rotation speed of the first oil pump, a rotation speed of a second oil pump, flow rates in the cooling branches, and an opening degree of a pressure control solenoid valve according to the driving pressure requirement and the cooling flow requirement of each power terminal.

18. The method according to claim 17, wherein the cooling branches comprise a first cooling branch, a second cooling branch, a third cooling branch, and a fourth cooling branch, the first cooling branch is configured to cool the drive motor, the second cooling branch is configured to cool the generator, the third cooling branch is configured to cool the clutch, and the fourth cooling branch is configured to cool the transmission system.

19. The method according to claim 17, wherein the control element comprises proportional adjustment solenoid valves, and each of the proportional adjustment solenoid valves is configured to receive a signal sent by a vehicle controller and to adjust an opening degree of each of the proportional adjustment solenoid valves according to the signal.

20. The method according to claim 17, wherein the hydraulic system further comprises a driving oil path, the driving oil path is connected between the oil tank and the clutch, the second oil pump and the pressure control solenoid valve are disposed on the driving oil path, the second oil pump is configured to pump the oil to the driving oil path, and the driving oil path is configured to control engagement and disengagement of the clutch.
